(19) United States
(12) Patent Application Publication
(10) Pub. No.: US 2008/0232134 A1
(43) Pub. Date: Sep. 25, 2008

(54) Replaceable LED light source device used in backlight module

(75) Inventors: Derchin Weng, Taipei (TW); Han-Wei Lu, Taipei (TW)

Correspondence Address: TROXELL LAW OFFICE PLLC, 5205 LEESBURG PIKE, SUITE 1404, FALLS CHURCH, VA, 22041, US

(73) Assignee: PROMATE ELECTRONIC CO., LTD.

(21) Appl. No.: 11/727,192

(22) Filed: Mar. 23, 2007

(51) Int. Cl. F21V 8/00

(52) U.S. Cl. 362/612

(57) ABSTRACT

A replaceable LED light source device used in a backlight module comprises a LED bar disposed with a plurality of LEDs thereon used for providing illumination and an attaching plate used for disposing the detachable LED bar within a case locating the backlight module therein. Thereby, the previous LED light source device can be replaced by a new one when any LED on the LED bar stops working.

### BACKGROUND OF THE INVENTION

1. Field of the Invention

The present invention relates to a LED light source device used in a backlight module and, more particularly, to a replaceable LED light source device used in a backlight module to substitute the previous light source device where the LEDs of the LED bar stop working.

2. Description of the Prior Art

With the dramatic development of the Internet and the wireless communication technology, information becomes easily accessible to everyone and thereby the personal information-related electronic products, such as notebooks, mobile phones, digital cameras, and personal digital assistants, are rapidly developed and grown. Going with the ascending trend of the market on the Internet digital information, Liquid Crystal Displays (LCD) is developed even faster and becomes thinner, lighter, less energy consumption, safer and able to be incorporated in the semiconductor manufacturing technology. However, a LCD needs extra light source for emitting light. Conventionally, a reflective LCD is backed with a layer of reflective material that is provided under the LCD panel for reflecting the ambient light back to the LCD panel to increase the brightness of the LCD panel. This light source is unable to provide enough light solely by reflecting the ambient light in dark places. Thus, the need of extra light source for brightening the LCD panel is increasing and, in present days, backlight module becomes one critical part of a LCD.

A backlight module comprises a light source device, a reflector, a guiding plate, and a pile of optical sheets. According to the position of the light source device, backlight modules are classified into two groups: direct-type backlight modules and edge-mounted backlight modules. Generally, the source light includes cold cathode fluorescent lamp (CCFL), hot cathode fluorescent lamp, electroluminescent light source, and light emitting diode (LED), and the CCFL is used most wildly. However, the LED is advantageous that it is high color, high brightness, Mercury free, and high color saturation. Compared with the CCFL as the light source of a backlight module used in a LCD, the LED can provide more additional values and best vision for users. Thereby, it is a tendency that more and more cold cathode fluorescent lamps are replaced by the LEDs as the light source used in backlight.

FIG. 6 shows the general structure of an edge-mounted backlight module conventionally used in a LCD. As shown in FIG. 6, an edge-mounted backlight module is disposed under a LCD panel D with a frame D1 and comprises a LED light source device A1, a reflector B1, a light guiding plate B2, and a pile of optical sheets B3. The backlight module is disposed within a case C. The LED light source device A1 includes a LED bar A11 and a plurality of LEDs A12 disposed thereon, wherein the LED bar A11 can be a metal plate, a printed circuit board, or a soft plate. The pile of optical sheets B3 further includes a first diffuser B31, a first bright enhancement sheet B32, a second bright enhancement sheet B33, and a second diffuser B34. The case C further includes a bottom case C1 and lateral walls C2. When the LEDs A12 of the LED light source device A1 are driven, uniform and highly right light can be provided and the generated light will be guided toward the LCD panel D via the light guiding plate B2 to increase the brightness and the Luminance uniformity of the LCD panel D. The reflector B1 is disposed beneath the light guiding plate B2 used for reflecting back the light from the LED light source device A1 into the light guiding plate B2 to prevent light leakage and enhance the light using efficiency. The diffusers B31, B34 are used for providing the LCD panel D uniform plane light source by optical diffusion effect of refraction, reflection, or scattering phenomenons generated when the light is passing through the diffusers B31, B34. However, the light passing through the diffuser B31 has low directivity. Thus, the light enhancement sheets B32, B33 are used for adjusting the light direction and focusing the light to elevate the brightness via light refraction and reflection.

The most critical part of the backlight module is the LEDs A12 of the LED light source device A1, the lifetime of which determines the lifetime of the whole backlight module. Besides, the light source device of the backlight module is usually necessary to be disposed within a narrow-and-small enclosed space because of the need for light weight of the backlight module in addition to high brightness. Thus, the heat generated during the illumination process is difficult to be dissipated and it will result in the high temperature of the backlight module. And the lifetime of the LED relates to its drive current and temperature. Thereby, the lifetime of a LED backlight module is usually less than 50,000 hours. Moreover, the LED light source device is disposed within a LED backlight module conventionally, and if the lifetime of the LED expires or the LED stops working for other different reasons during the operation process, the whole backlight module either has to be discarded or has to be disassembled and reassembled with much time and labor. It is not economic and brings much inconvenience to the users.

In order to overcome the above-stated disadvantages to provide a replaceable LED light source device able to substitute the previous one stopping working without discarding or disassembling and reassembling the whole backlight module witch takes much time and labor, the inventor had the motive to try and develop the present invention after hard research.

### SUMMARY OF THE INVENTION

The primary object of the present invention is to provide a replaceable LED light source device used in a backlight module to replace a LED light source device, which stops working for different reasons during the operation process, without discarding or disassembling and reassembling the whole backlight module which takes much time and labor.

In order to achieve above object, the present invention provides a replaceable LED light source device used in a backlight module comprising a LED bar disposed with a plurality of LEDs thereon used for providing illumination and an attaching plate used for disposing the detachable LED bar within a case locating the backlight module therein. Thereby, a previous LED light source device can be replaced when any LED of the LED bar of the previous LED light source stops working.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is an exploded perspective view of a first embodiment of a replaceable LED light source device used in a backlight module according to the present invention.

FIG. 2 is a perspective view of the FIG. 1.

FIG. 3 shows the using state of the FIG. 1, wherein a replaceable LED light source device is drawing out.

FIG. 4 is a perspective view of a second embodiment of a replaceable LED light source device used in a backlight module according to the present invention.

FIG. 5 is a perspective view of a third embodiment of a replaceable LED light source device used in a backlight module according to the present invention.

FIG. 6 is an exploded perspective view of a conventional LED backlight module.

### DETAILED DESCRIPTION OF THE PREFERRED EMBODIMENTS

The present invention provides a replaceable LED light source device 11 used in a backlight module, comprising a detachable LED bar 111 having a plurality of LEDs 112 thereon providing illumination of the backlight module, and an attaching plate 113, 1131 for disposing the detachable LED bar 111 within a case 2 locating the backlight module therein via an aperture 24, 25 on the case 2.

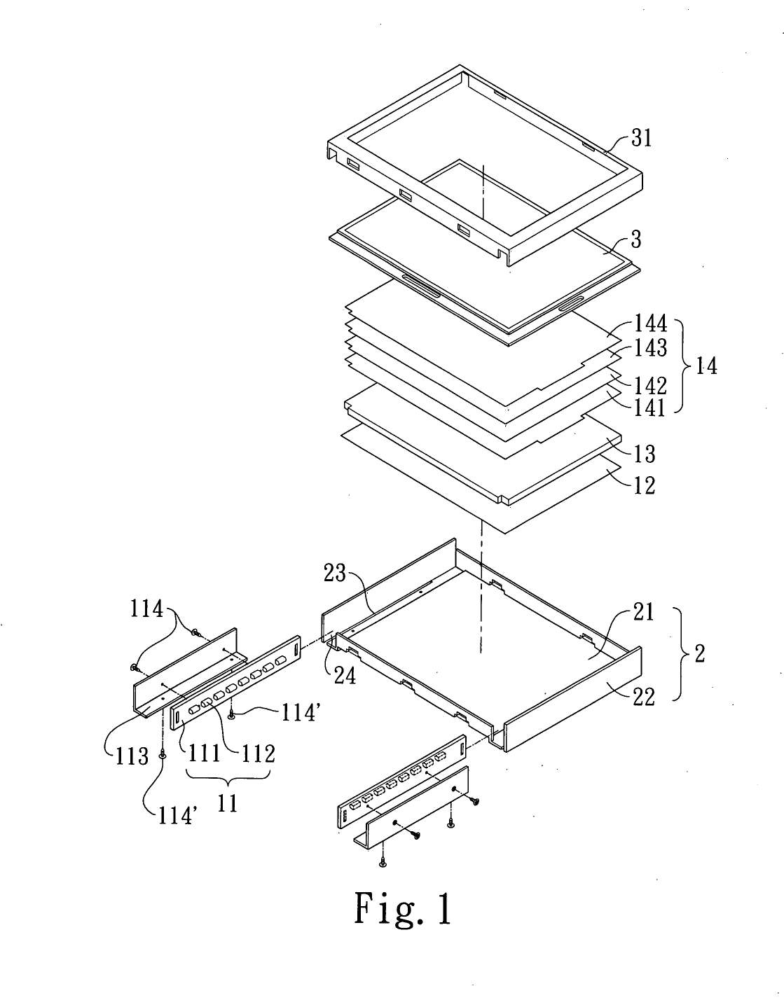

FIG. 1-3 shows a first embodiment of a replaceable LED light source device 11 used in a LED backlight module according to the present invention, wherein FIG. 1 shows an exploded perspective view of the first embodiment. As shown in FIG. 1, backlight module is placed under a LCD panel 3 with a frame 31 and comprises a LED light source device 11, a reflector 12, a light guiding plate 13, and a pile of optical sheets 14. The backlight module is disposed within a case 2. The LED light source device 11 includes a LED bar 111 and a plurality of LEDs 112 disposed thereon, wherein the LED bar 111 can be a metal plate, a printed circuit board, or a soft plate. The pile of optical sheets 14 further includes a first diffuser 141, a first bright enhancement sheet 142, a second bright enhancement sheet 143, and a second diffuser 144. The case 2 further includes a bottom case 21 and lateral walls 22. The LED light source device is disposed on one lateral side within the case via a L-shape attaching plate 113, wherein the LED bar 111 of the LED light source device 11 is connected with one side of the L-shape attaching plate 113 via a first attaching part 114 and the first attaching part 114 in this embodiment includes two screws; another side of the L-shape attaching plate 113 is connected with the bottom 21 of the case 2 via a second attaching part 114′ and the second attaching part 114′ in this embodiment also includes two screws. Besides, on the lateral side of the bottom 21 of the case 2 is provided with a groove 23 for the L-shape attaching plate 113 in connection with the LED light source device 11 sliding into the case 2 via the aperture 24 on one lateral wall 22 of the case 2 when in practice. The side of the L-shape attaching plate 113 located outside of the case 2 is attached to the bottom 21 of the case 2 via locking the second part 114′ when the L-shape attaching plate 113 is inserted to contact the end of the groove 23.

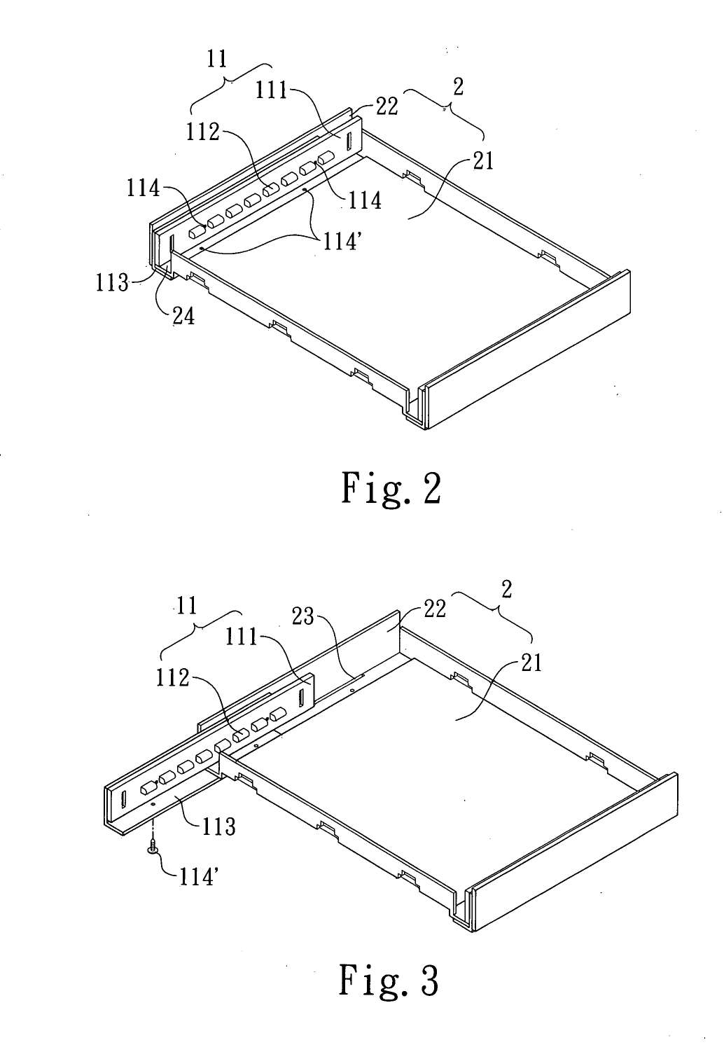

FIG. 2 shows a perspective view of the FIG. 1. For describing this embodiment conveniently, the reflector 12, light guiding plate 13, and the pile of optical sheets in FIG. 1 are all removed. As shown in FIG. 2, the LED light source device 11 is attached to the lateral side within the case 2 via the L-shape attaching plate 113, the first attaching part 114, and the second attaching part 114′.

When the LED light source device 11 stops working for different reasons during the operation process, as shown in FIG. 3, the previous LED light source device 11 can be removed by unlocking the second attaching part 114′ from the bottom 21 of the case 2 and drawing the previous one along the groove 23 out of the case 2 via the aperture 24 to be replaced with a new one.

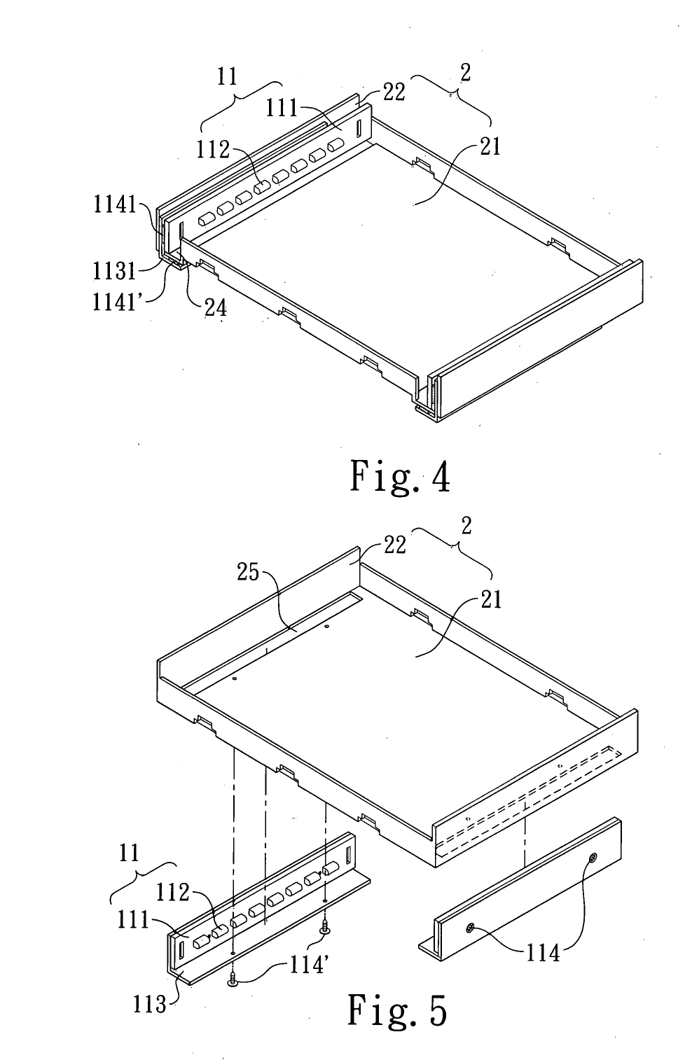

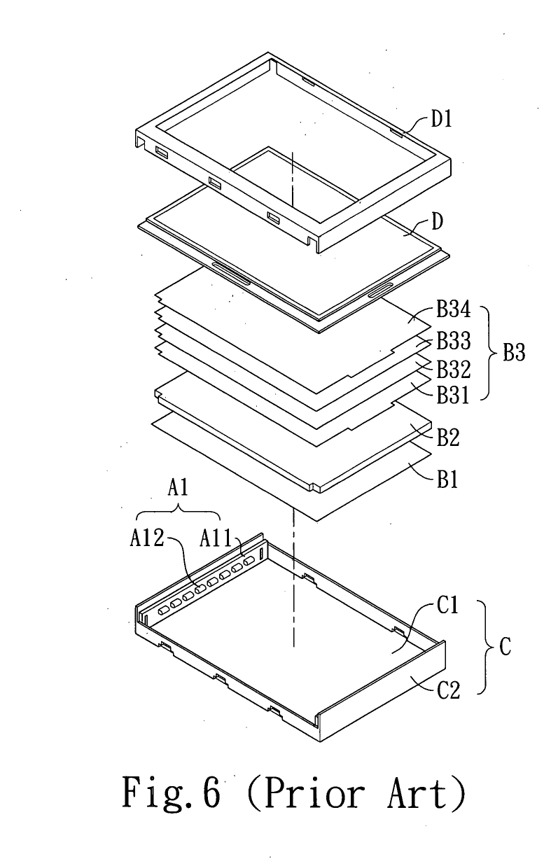

FIG. 4 shows a second embodiment of the present invention. For describing this embodiment conveniently, we will assign the same structure with the same number in the first embodiment. The difference between the two embodiments is that the first and the second attaching parts 1141, 1141′ are made by adhesive heat-conductive material in the second embodiment, such as a thermal-conductive adhesive tape, a thermal-conductive double-side adhesive tape, or an adhesive thermal pad. Besides, the L-shape attaching plate 1131 and the case 2 are made by metal, and are preferably made by copper or aluminum. In this embodiment, the first attaching part 1141 includes two adhesive thermal pads used for attaching the L-shape plate 1131 to the detachable LED bar 111, and the second attaching part 1141′ also includes two adhesive thermal-conductive pads used for attaching the L-shape attaching plate 1131 to the bottom 21 of the case 2. In practice, the L-shape attaching plate 1131 connected with the LED light source device 11 slides along the groove 23 into the case 2 via the aperture 24 on the lateral wall 22 of the case 2, and then the side of the L-shape attaching plate 1131 located outside the case 2 is attached to the bottom 21 of the case 2 so that the LED light source device 11 can be attached to one lateral side within the case 2. The purpose of this designation is not only to make the LED light source device 11 replaceable, but also to conduct the heat generated from the LEDs 112 on the LED bar 111 to the L-shape attaching plate 1131 via the first attaching part 1141, then to the metal case 2 via the second attaching part 1141′, and finally dissipate the heat from the metal case 2. Thereby, the reduction of the lifetime of the LEDs 112 of the LED light source device 11 as a result of failing to dissipate heat can be overcome, and the lifetime of the LED light source device 11 can be lengthened accordingly. The description of other structures identical to those in the first embodiment mentioned above is omitted here.

FIG. 5 shows a third embodiment of the present invention. For describing the embodiment conveniently, we will assign the same structure with the same number in the first embodiment. The difference between the two embodiments is that an aperture 25 is provided in this embodiment on each lateral side of the bottom 21 of the case 2. The L-shape attaching plate 113 is connected with the LED bar 111 via the first attaching part 114 and connected with the bottom 21 of the case 2 via the second attaching part 114′, so that the LED light source device 11 is attached to each lateral side of the bottom 21 within the case 2. In this embodiment, the two attaching parts 114, 114′ are all screws. Moreover, the LED light source device 11 stopping working can be removed by unlocking the second attaching part 114′ from the bottom 21 of the case 2 and taking the previous one out of the case 2 directly via the aperture 25 to be replaced with a new one.

Accordingly, as disclosed in the above description and attached drawings, the present invention can provide a replaceable LED light source device which can be used to replace a previous LED light source device stopping working and can dissipate the heat generated from the LEDs on the LED bar. It is new and can be put into industrial use.

While the invention has been described with reference to certain embodiments, it will be understood by those skilled in the art that various changes may be made and equivalents may be substituted without departing from the scope of the present invention.

What is claimed is:

1. A replaceable LED light source device used in a backlight module, comprising:
a detachable LED bar having a plurality of LEDs thereon for providing illumination of the backlight module;
an attaching plate for disposing the detachable LED bar within a case locating the backlight module therein via an aperture on the case.

2. The replaceable LED light source device used in a backlight module as claimed in claim 1, wherein the attaching plate is connected with the detachable LED bar via a first attaching part and with the case via a second attaching part, so that when any LED on the LED bar of a LED light source device stops working, a new LED light source device can replace the previous one by removing the second attaching part.

3. The replaceable LED light source device used in a backlight module as claimed in claim 2, wherein the attaching part can be a screw, sticky tape, or a double-side adhesive tape.

4. The replaceable LED light source device used in a backlight module as claimed in claim 1, wherein the aperture is provided on the lateral side of the case.

5. The replaceable LED light source device used in a backlight module as claimed in claim 1, wherein the aperture is provided on the bottom of the case.

6. The replaceable LED light source device used in a backlight module as claimed in claim 1, wherein the case is made by metal.

7. The replaceable LED light source device used in a backlight module as claimed in claim 6, wherein the metal for forming the case is copper or aluminum.

8. The replaceable LED light source device used in a backlight module as claimed in claim 6, wherein the attaching plate is made by metal and the attaching part is made by thermal-conductive material, so that the heat generated from the LED can be conducted to the case and dissipated therefrom.

9. The replaceable LED light source device used in a backlight module as claimed in claim 8, wherein the metal for forming the attaching plate is copper or aluminum.

10. The replaceable LED light source device used in a backlight module as claimed in claim 8, wherein the thermal-conductive material for forming the attaching part is selected from the group of a thermal-conductive adhesive tape, a thermal-conductive double-side adhesive tape, and an adhesive thermal pad.
